(19) United States
(12) Patent Application Publication
(10) Pub. No.: US 2011/0089687 A1
(43) Pub. Date: Apr. 21, 2011

(54) MODULAR FITTING WITH GRIPPING DEVICE FOR CONDUITS

(75) Inventors: Johan Jan Goemans, Concord, OH (US); Harold F. Kingsmill, South Euclid, OH (US); Kennan J. Malec, Gates Mills, OH (US); William T. Nauck, Chagrin Falls, OH (US); Kevin P. O'Brien, Willoughby, OH (US); Bruce E. Schneider, Solon, OH (US); Peter C. Williams, Cleveland Heights, OH (US); Mark A. Clason, Orwell, OH (US); Joseph M. Gorley, Cleveland Hights, OH (US); Jeffrey S. Rayle, Rocky River, OH (US)

(73) Assignee: Swagelok Company, Solon, OH (US)

(21) Appl. No.: 12/999,470

(22) PCT Filed: Jul. 9, 2009
(86) PCT No.: PCT/US09/50064

§ 371 Date: Dec. 16, 2010

Related U.S. Application Data
(60) Provisional application No. 61/079,913, filed on Jul. 11, 2008.
(60) Provisional application No. 61/079,911, filed on Jul. 11, 2008.

(51) Int. Cl. F16L 19/08; B23P 11/00

(52) U.S. Cl. 285/345; 29/890.14

(57) ABSTRACT

A modular fitting for conduits such as tube and pipe comprises a universal body (12) having at least two selectable configurations and at least one or more connecting parts that when joined with the body form a fitting. The body includes a drive member (24) and a conduit gripping member (28), and in an exemplary embodiment the conduit gripping member may be in the form of a conical spring (28) that grips the conduit (c) when axially compressed during pull-up. The modular design for a fitting facilitates postponement of final fitting configuration and assembly beyond the manufacturing facility to an end user or other location and time.

### CROSS REFERENCE TO RELATED APPLICATIONS

This application claims the benefit of U.S. Provisional patent application Ser. No. 61/079,911 filed on Jul. 11, 2008, for MODULAR FITTING WITH GRIPPING DEVICE FOR CONDUITS, and U.S. Provisional patent application Ser. No. 61/079,913 filed on Jul. 11, 2008, for MODULAR FITTING FOR CONDUITS, the entire disclosures of which are fully incorporated herein by reference.

### BACKGROUND OF THE DISCLOSURE

The present disclosure relates to fittings such as may be used, for example, to connect a conduit to either another conduit or to a fluid flow component such as a valve, a regulator, a manifold, filter and so on. Examples of such fittings include but are not limited to elbows, straights, t-fittings and so on. A fitting typically includes one or more end connection configurations that allow the fitting to be connected into or to complete a fluid flow path. Some fitting designs may have eight or more end connection configurations. The wide variety of fitting shapes and end connection configurations results in large inventory requirements because fittings are typically manufactured as single piece components from raw material that may be machined, forged, molded or cast, thus also necessitating significant lead times for orders.

### SUMMARY OF THE DISCLOSURE

In accordance with an inventive aspect of the disclosure, a fitting for conduit connections is realized in a modular or multi-piece arrangement. This may include two or more parts that are each formed to a finished condition and then later assembled into a desired fitting configuration. The two or more parts may include a first part or body and a second part that is to be joined to the body, such as for example an end connection or other component. In one embodiment, a body is formed that includes a flow path therein with at least two ports. The body may thus be used as a configurable or universal fitting component or base to which one or more selectable end connections, parts or components may be subsequently joined or assembled to faun a complete fitting. Use of a configurable base or alternatively a base having a selectable configuration along with selectable end connections, parts or components permits postponement of final configuration and assembly of a fitting so as to reduce inventory and lead times otherwise needed for pre-manufactured fitting configurations. The present disclosure thus further contemplates inventive aspects in product design and methods of manufacture for configurable fittings that allow postponement of final configuration and assembly of a fitting beyond the manufacturing facility to an end user or other location and time. The modular design also facilitates postponement of final configuration and assembly even at the manufacturing facility.

These and other aspects and advantages of the inventions disclosed herein will be readily apparent to those skilled in the art from a reading of the following detailed description of the exemplary embodiments in view of the accompanying drawings.

### BRIEF DESCRIPTION OF THE DRAWINGS

FIG. 1 is an embodiment of a four port modular fitting body and an exemplary end connection, illustrated in cross-section perspective;

FIG. 1A is an embodiment of a modular fitting in an assembled condition;

FIG. 2 is an enlarged illustration of a conduit gripping arrangement such as may be used in the modular fitting of FIG. 1;

FIG. 3 illustrates the conduit gripping arrangement of FIG. 2 in a pulled-up condition;

FIG. 3A is an enlarged view of the circled portion of FIG. 3;

FIG. 4 illustrates a second embodiment of a conduit griping arrangement for a modular fitting;

FIGS. 5A and 5B illustrate another embodiment of a modular fitting using a flush drive member.

FIG. 6 is an embodiment of a modular two port fitting in a pre-assembled condition;

FIG. 7 is the modular fitting of FIG. 6 after assembly;

FIG. 8 is an embodiment of a modular four port fitting in a pre-assembled condition;

FIG. 9 is the modular fitting of FIG. 8 after assembly;

FIGS. 10A-D illustrate another embodiment of a modular two port fitting, with FIG. 10A being a side view of a body; FIG. 10B being a cross-section of the body of FIG. 10A along the line 10B-10B; FIG. 10C shows the body of FIG. 10A assembled with two selectable end connectors; and FIG. 10C illustrates in perspective an embodiment of a selectable end connector.

### DESCRIPTION OF THE EXEMPLARY EMBODIMENTS

While the various embodiments described herein are to specific configurations, such as exemplary body configurations and end connection configurations, such embodiments are exemplary in nature and should not be construed in a limiting sense. Many different types of components and end connections as well as many types of body configurations may be used, far too many to identify, illustrate or disclose herein. Rather, the exemplary embodiments are intended to illustrate the broad conceptual features of the inventive aspects of the disclosure, with the actual implementation and configurations largely being a matter of design choice and selection based on the intended end uses. Although the concepts disclosed herein are described in terms of metal fittings for metal tube or pipe conduits, those skilled in the art will appreciate that the various inventions may be used with non-metal fitting parts with metal or non-metal conduit materials, or any combination thereof.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, circuits, devices and components, software, hardware, control logic, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure, however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention, the inventions instead being set forth in the appended claims. Descriptions of exemplary methods or processes are not limited to inclusion of all steps as being required in all cases, nor is the order that the steps are presented to be construed as required or necessary unless expressly so stated.

As an introduction, the inventions are directed to providing a modular fitting that has many benefits especially for the ultimate end user of the fitting. One benefit is that a modular fitting may be configured and assembled from a number of components or parts that are selected from a group of components or parts that may be used in a number of different assemblies or fitting configurations. In other words, the end user or other person needing a fitting of a desired configuration and functionality may select the appropriate parts from a larger group of available parts to assemble a desired fitting, where the selected parts may be used in any number of different ways. For example, there may be available a number of different first components or bodies, such as for example, a body for an elbow, crosses, a straight, a union, a t-fitting and so on. Some bodies may be arranged to allow use in more than one style fitting, for example a four port body may be configurable as a t-fitting, a cross-fitting, and elbow or pairs of elbows and so on. Each body choice may itself be a universal design meaning that it may be assembled into a variety of different configurations. There may also be a wide variety of second or more components that may be selected and assembled with the selected body, including for example, different end connections, plugs and so on. By selecting from a number of universal bodies and connecting pieces, inventory control is greatly enhanced in that a user need not try to anticipate how many fittings of a certain type will be needed over a period of time, but rather can stock various components that can be mixed and matched to achieve a desired fitting design. Alternatively, distributors need not stock lower volume fitting designs along with higher volume, since both can be made from selecting among the available component choices.

Another benefit is that the manufacturer of the various components can achieve economy of scale. For example, rather than having to make five different types of fittings and inventory all five, a manufacturer might be able to make one style body that can be assembled into many different fitting configurations. This postponement of final configuration and assembly, either at the manufacturer or elsewhere, can greatly reduce margin costs, inventory costs and expedite delivery schedules. Still another benefit is that the modular fitting concept allows for postponement of final assembly to the field or a distributor or other facility beyond the manufacturing site or sites of the various fitting components.

We distinguish the term “fittings” from other fluid component structures such as manifolds, for example. As general background, fitting is a component used in the art for interconnecting sections of pipe and tube with other sections of pipe and tube or with fluid flow components such as, for example, valve, filters, regulators and so on. Such fittings, for example, elbows, crosses, tees, and unions, are typically of a standard sizes that are not much bigger than is needed to accommodate the fluid paths. In other words, fittings typically are formed of bodies that are machined or otherwise formed to contain one or more fluid paths. The amount of material that makes up a fitting body is determined by the pressure rating of the fitting and the size of the fluid path. Any use of excess material would represent unnecessary cost. In contrast, manifolds tend to be larger more complex and single use bodies of non-standardized sizes and that usually have multiple distribution paths and, for example, are not be used simply to interconnect, for example, tube or pipe ends.

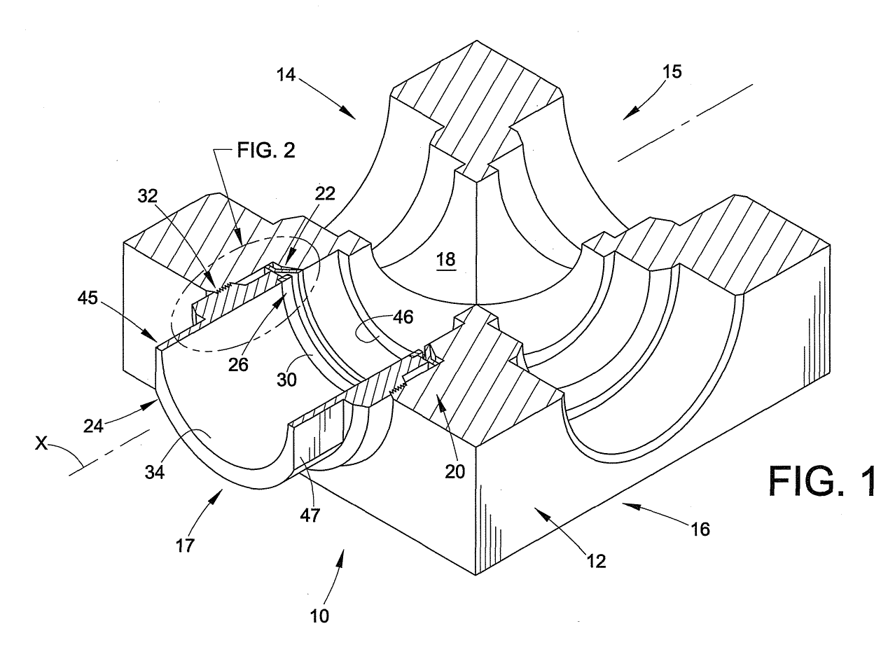

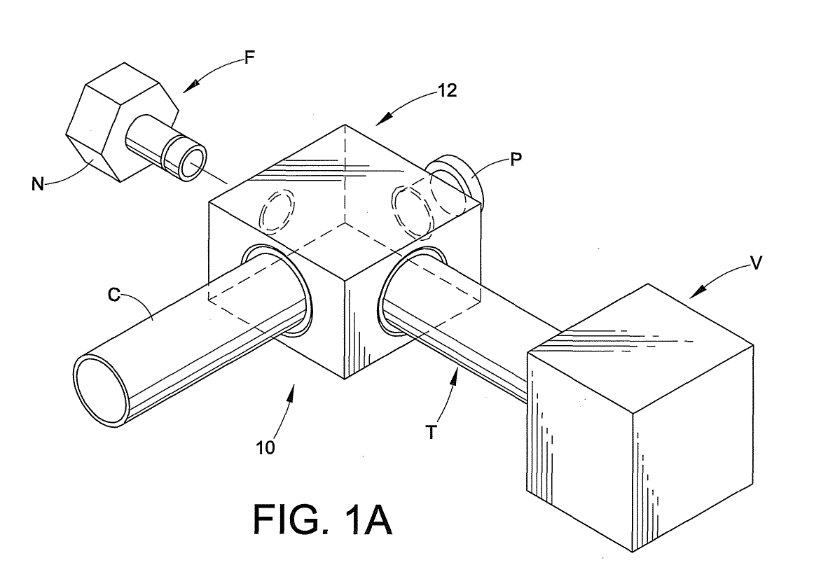

FIG. 1A illustrates a modular fitting 10 which in this example may be but need not be used as a four port fitting. The fitting 10 includes a first fitting component or body 12 to which may be connected a wide variety of different type components. For example, a conduit C such as tube or pipe may be connected to the fitting, or a conduit with an end connector F. Such an end connector F may be, for example, a nut N and body (not shown) of a ferrule type tube fitting, also known as flareless fittings, or a flared fitting, a sanitary fitting such as a clamped fitting, or any other suitable end connection. A valve V or any other type of flow component might also be connected to the fitting 10, such as for example, with a tube stub T. Yet another example might be a passive component such as a simple plug P used to close off a flow path otherwise available with the modular fitting 10. The examples are far too numerous to list even in categories, though active flow components, passive flow components, fittings, conduits and so on will give those skilled in the art an appreciation of the flexibility and ubiquitous application that the modular fitting provides. Although a four port modular fitting is illustrated herein, the present inventions are not limited to such a configuration as will be further described below, nor is a modular fitting restricted to any of the shapes and configurations shown herein.

As used herein, the term ‘modular fitting’ is used to refer to the body and its related parts that allow for a fluid tight mechanical connection with the attached components, as well as the fully assembled structure in which one or more components are connected to the body, such as end connections, conduits, flow control devices and so on. This dual use of ‘modular fitting’ is used because in many cases, a ‘fitting’ may be considered to be a device that allows interconnection of fluid components, such as by the use of a flareless fitting for example, whereas we also intend modular fitting to more broadly cover the concept of a device that allows for fluid tight mechanical connections, with a variety and number of configurations as needed.

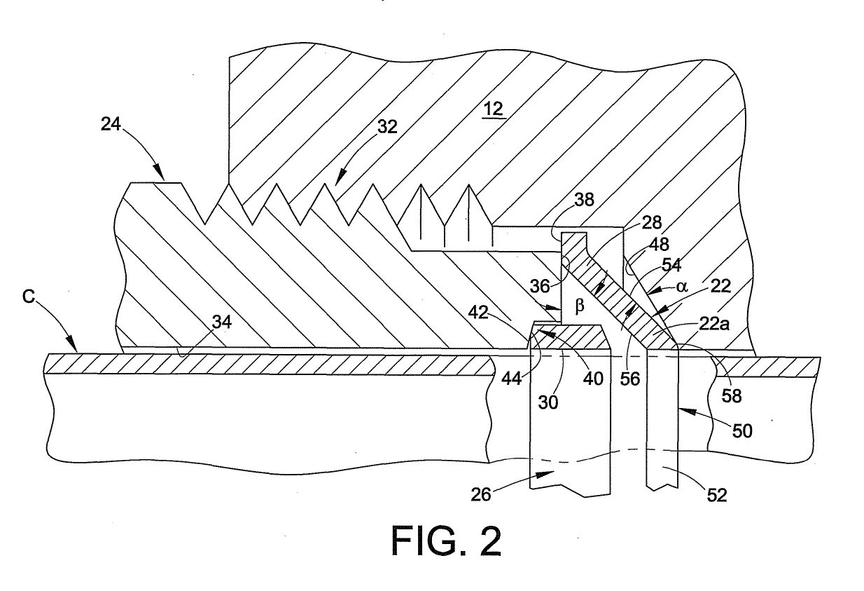

FIGS. 1 and 2 illustrate a first embodiment of a modular or multi-piece fitting 10. By modular is meant a construct of two or more components, pieces or parts that may be assembled or arranged in a configuration that is selected from a plurality of possible configurations. In such modular designs, the number of possible or selectable configurations is limited only by the number and variety of selectable individual pieces or parts and the number of configurations of those pieces and parts.

The fitting 10 includes a first part in the form of a configurable body or base 12. We use the terms base, body and block and similar terms to refer to any component that provides one or more fluid paths between selected ports depending on the final configuration for the fitting that the base will be used. It is contemplated that in general an assembler or user may select from a variety of different configurable bodies, but in some cases a single style body may be configurable in all the ways that a particular user would need. We thus refer to the base or body as being universal if it can support a number of different final or intermediate configurations depending on which additional components are selected for assembly with the base, and thus we use the term universal in its broadest sense to refer to a structure that has more than one available configuration.

The body 12 in this embodiment may be realized in the form of a block that includes a first port or opening 14, a second port or opening 15, a third port or opening 16 and a fourth port or opening 17. The base 12 may further include an internal flow passage 18 that fluidly connects all the ports together. However, alternative designs may have a greater number of internal flow passages. For example, in an alternative arrangement there may be a flow passage that connects the first and second ports and a second flow passage that connects the third and fourth ports. Many other base flow passage designs may be provided as needed. The present inventions are not limited to any particular number of ports or passages associated with the body 12, from as few as one (such as for example a plug end fitting) to any number greater than one as determined simply by the size requirements for the body (its footprint), ports and passages.

The body 12 may be manufactured by any suitable method including but not limited to machining from bar stock, forging, molding or casting. The passage 18 or plural passages when used may be a machined formation or formed as part of a molding or casting operation, for example. Although preferably a universal or configurable body is a one piece component, such is not required, and a body may be formed as two or more pieces that are joined together.

The fitting 10 further includes one or more body connections or connection assemblies 20 (in FIG. 1 only one connection assembly 20 is shown) that allows for a fluid tight mechanical connection of conduits such as tube and pipe to the body 12 at one or more of the port sites. Since the illustrated modular fitting 10 is a four port device, there may typically be four connection assemblies 20, and all the assemblies may be but need not be the same. However, depending on a selected configuration, one or more of the ports 14, 15, 16, 17 may not utilize a connection assembly 20. For example, if one of the ports is to be simply plugged, a plug may be threadably or otherwise connected to the body 12 without the need for a connection assembly 20. Moreover, although for greater simplicity it is contemplated that many users will want to have the same connection assembly 20 for the ports, in some applications it may be desired or needed to provide more than one style connection assembly 20 in one or more of the ports 14, 15, 16, 17. This might be the case, for example, when a connection is being made to a device that is not a conduit—the example herein of a plug is one example where a port may be provided with a connection arrangement that differs in design from the connection assembly 20 herein. Therefore, the connection assembly illustrated herein is only one of many different ways to realize a fluid tight mechanical connection to the body 12. The connection assembly 20 herein is useful, among other things, to connect a tube or pipe or other conduit stub to the body 12.

The connection assembly 20 in this embodiment comprises a conduit gripping device 22 (also referred to herein as a conduit gripping member or conduit gripping device 22), a drive member 24 and an optional supporting member 26, which in this embodiment may be realized in the form of a collet or swage ring 26. FIG. 2 illustrates this assembly in enlarged detail (note that in FIG. 2 we have included a conduit stub C in the drawing as compared to FIG. 1). In this embodiment, the gripping device 22 may be realized in the faun of a washer or spring body 28. In one embodiment, the spring body 28 may be in the form of a Bellville washer. The supporting member 26 may be realized, for example, in the form of an annular ring-like device having a smooth interior cylindrical wall 30 that is closely received about the conduit C outer surface. The drive member 24 is provided with suitable structure for joining the drive member to the body 12, in this embodiment the drive member 24 and body 12 include a threaded connection 32 so that as the drive member 24 is screwed and tightened into the body 12, the gripping device 22 tightly and strongly engages the conduit, and the supporting member 26 also tightly grips and engages the conduit behind the gripping device. The supporting member 26 provides mechanical support to the gripping device 22, in some cases even if the drive member 24 is loosened, and also provides isolation between the stress region or stress riser where the gripping device grips the conduit, and the down-conduit vibration or stress such as may occur from bending moments.

In the case of a threaded connection 32 between the drive member 24 and the body 12, the drive member 24 may act as a retaining device to hold the drive member, gripping device 22 and supporting member 26 together with the body 12 as a preassembly or cartridge type assembly. For example, the drive member 24 might be tightened to a finger tight condition. By allowing for a preassembled structure, the manufacturer can reduce the incidence of improper assembly of parts, such as for example forgetting to install the gripping device 22 or installing it backwards. All four ports may have this preassembly or other preassembly as needed or not. Even in the case where a threaded connection is not used between the drive member 24 and the body 12, there are alternative ways, such as an adhesive for example, to hold the fitting parts together as a preassembled fitting.

The drive member 24 may include a smooth cylindrical wall 34 that closely receives the conduit end when the fitting 10 is going to be installed onto the conduit. The drive member 24 further may include an inward optionally radial first drive surface 36 that engages a radially outer flange 38 of the gripping device 22 during pull-up. The first drive surface 36 may or may not contact the gripping ring 22 in a finger-tight condition, though preferably it does. This drive surface also need not be planar or radial, but may have different contours and profiles depending on the nature of the drive forces to be applied to the gripping device 22. The drive member 24 may also include an optional pocket 40 funned by a tapered second drive surface 42 that is axially recessed from the first drive surface 36. A rearward end of the collet ring 26 may be received in this pocket 40 so that during pull-up the tapered drive surface 42 engages a driven surface 44 of the supporting member 26.

The drive member 24 may include an optional extension portion 45 (see FIG. 1) that extends axially outward beyond the outer surface of the base 12. This extension 45 may be provided with wrench flats 47 to facilitate tightening the drive member 24 during pull-up. In an alternative embodiment, the drive member 24 may be flush or even recessed from the outer surface of the base 12, and a tool used that can turn the drive member so as to pull up the fitting 10.

Since the illustration of FIG. 2 is in the finger tight condition, it will be noted that the drive member 24 will initially contact and move forwardly the outer flange 38 of the gripping device 22 before the forward end of the supporting member 26 engages the gripping device 22. In this manner, the gripping device 22 is able to deform and spring load into position before the collet ring 26 applies a significant load against the gripping device 22, because once the collet ring begins to be compressed against the lower or radially inner portion 22a of the gripping device 22, pull-up will be nearly completed.

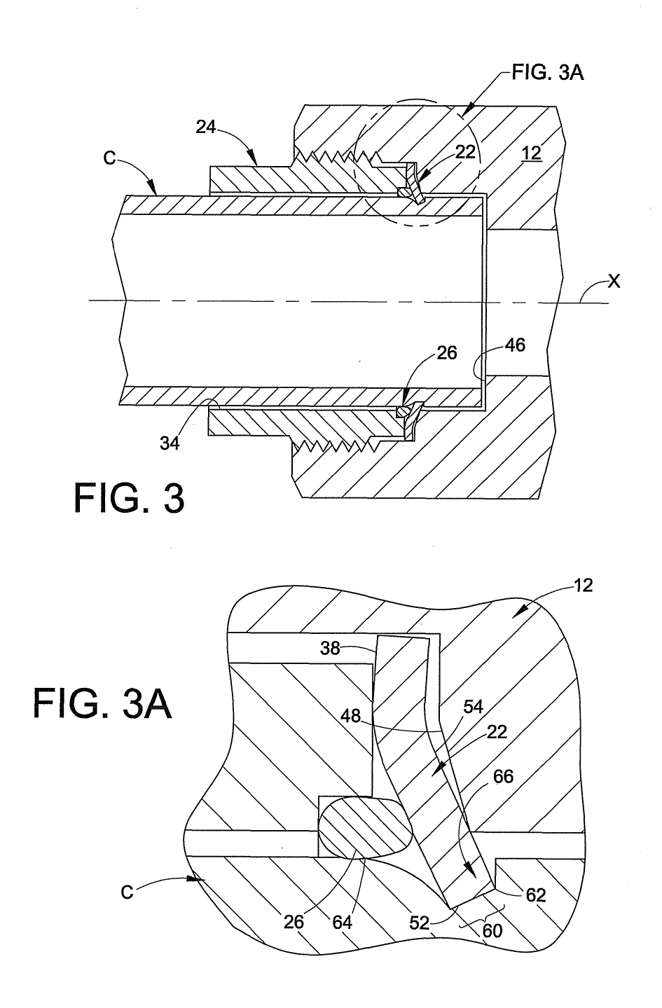

The body 12 may be provided with a counterbore shoulder 46 (FIG. 3) against which the conduit end is bottomed. The conduit end is slideably inserted through the drive member 24, the supporting member 26 and the gripping device 22 up against the shoulder 46 when the fitting 10 is going to be connected to a conduit. The conduit may or may not tightly bottom or remain bottomed when the assembly is in a finger tight condition but it is usually desirable, although not required in all designs, that the conduit be bottomed against the shoulder 46 by the time that pull-up is completed. The body 12 may also be provided with a tapered face 48 to facilitate action of the gripping device 22 as will be further explained herein below.

As noted above, in the illustrated exemplary embodiment of FIGS. 1 and 2, the conduit gripping member 22 may be realized in the faun of a conically shaped body 28 which in some respects may be comparable to a spring washer. Accordingly, the conical body 28 may include a central opening 50 that is defined in this example by a radially inner cylindrical wall 52, and that allows the conduit C to be slid there through during assembly of the fitting 10. A common example of a spring washer geometry is a Belleville spring, although such geometry is only exemplary. Belleville springs often are used to provide a live-load or bias against a surface in a direction along a central longitudinal axis of the spring, in terms of FIGS. 1 and 3 in a direction that is parallel to the axis X. Our concept in one embodiment is to use a spring washer approach to effect conduit grip and optionally a seal by a radial compression against the conduit outer surface C brought about when the spring is axially loaded. An axial load against the conduit gripping member 22 causes the washer-like device to deform to a flatter condition which produces an inward radial compression of the conduit gripping member against the conduit C. This concept of using a conduit gripping member such as in an exemplary form of a spring washer to effectively grip and optionally seal against an outer surface of a conduit is fully described in International Patent Application number PCT/US2006/024776 published as WO 2007/002576 A2 on Jan. 4, 2007 and fully incorporated herein by reference.

In the embodiment of FIGS. 1-3, the conduit gripping member 22 comprises two generally parallel frusto-conical walls 54, 56 that extend from the radially inner wall 52 to the optional radial extension or flange 38. A typical Belleville spring does not use the flange 38, and the present inventions may be used with such conventional spring designs in many cases, or other spring or washer designs to name a few examples. The outer wall 54 and the inner cylindrical wall 52 converge at a front end or edge 58 of the conduit gripping member 22. This front edge 58 may be but need not be a sharp edge, and preferably may be of such configuration and shape as to indent or embed into the outer surface of the conduit when the fitting 10 is pulled up. By indenting into the surface, the conduit gripping member 22 creates a significant stress riser and further exhibits a high gripping strength against any tendency for the conduit C to try to back out of the fitting, especially under pressure. For lower pressure applications, however, it may not be necessary to have a biting or indenting type effect on the conduit. The conduit gripping member 22 may have many alternative geometries and configurations to promote the grip and seal functions as needed and as needed for particular overall fitting 10 configurations and designs.

The conduit gripping member 22 initially engages the tapered interior surface 48 of the body 12 down near the conduit surface, as illustrated in FIG. 2 in the finger-tight condition of the fitting. The interior surface 48 in this embodiment is frusto-conical so as to present a camming surface for the conduit gripping member 22, and may also be used to provide a limit on the deflection of the conduit gripping member 22 during pull-up. The forward or outer spring wall 54 and the interior surface 48 may define an included suitable angle α, while the rearward or inner spring wall 56 and the first drive surface 36 may define an included suitable angle β. In many cases, the angles α and β may be the same or nearly the same, but in other cases they may be different, depending on the design and operation of the conduit gripping member 22 as well as the design and configuration of the drive surface 36 and the camming surface 48. The surfaces 54 and 48 cooperate to control deflection of the conduit gripping member 22 in a manner desired to achieve the desired grip and optional seal against the conduit C outer surface. This control of the deflection may be further enhanced with the use of the optional radial extension 38 that engages the first drive surface 36. As the drive member 24 is axially moved against the conduit gripping member 22, axial movement of the forward edge 58 is restricted by the body 12, and so the spring washer begins to flatten, which in cross-section appears as the walls 54, 56 moving towards a more vertical orientation. This causes an inward contraction of the cylindrical wall 52, in other words a decrease in its diameter, thus causing the forward edge 58 to indent or bite into the conduit. The inner cylindrical wall 52 may optionally to some extent swage or collet the conduit outer surface, but this is not necessary in this embodiment because the supporting member 26 is provided for that purpose.

During pull-up, the supporting member 26 is also moved forward axially and engages the inner portion of the conduit gripping member 22. As tightening continues, the supporting member 22 will plastically deform so as to collet or swage the conduit at a location that is axially rearward of the indented forward edge 58 of the conduit gripping device 22. Although the conduit gripping device 22 may also be designed to have this colleting or swaging action, the use of the separate supporting member 26 provides a beefier mass of material compressed against the conduit away from the stress region of the indented forward edge 58. By collet is meant either a plastic or elastic deformation of the supporting member 26 against the conduit to cause a radial strain into the conduit, resulting in a region of radial load axially behind the indented edge 58 to isolate the stress region of the indented edge from down-conduit vibration, bending moments and other forces that could weaken the ability of the conduit gripping member 22 to grip the conduit C. Alternatively the supporting member 26 could swage against the conduit outer surface where swaging is commonly referred to as a plastic deformation of the conduit to provide the radial strain into the conduit such that the conduit surface is radially compressed to a smaller diameter. For designs that use a colleting action, the radial strain into the conduit may accompany an elastic deformation and not necessarily a plastic deformation. Whether considered to be a swage, collet or other radial strain action, a notable outcome is that the supporting member 26 helps isolate the stress region of the indented edge 58 from down-conduit vibration, bending moments and other forces that could weaken the ability of the conduit gripping device 22 to grip the conduit C.

Because the conduit gripping member 22 does not necessarily fully plastically deform and stores potential energy as it is flattened, we consider this design to be live loaded, and further, the design allows for re-make of the fitting 10, in other words, a fully tightened fitting may be untightened and then re-made with the same resulting conduit grip and seal as needed. Note further that as system pressure increases, the pressure force tends to push the conduit back out of the fitting 10 (as viewed in FIG. 2, from right to left for example). For designs in which the conduit gripping member 22 convex side faces the high side system pressure, this tendency for the conduit to attempt to shift out of the fitting results in the conduit gripping member 22 becoming even more compressed, causing the conduit gripping member 22 to indent further into the conduit and also grip the conduit surface tighter. We call this action an energized conduit grip because the gripping strength increases with increasing system pressure.

With reference to FIGS. 3 and 3A, we illustrate an exemplary configuration of the fitting 10 in a fully pulled up and tightened condition. It will be noted that the gripping member 22 is somewhat flattened sufficiently to achieve the desired conduit gripping force by indenting into the conduit outer surface in the region 60 (FIG. 3A) the now smaller cylindrical wall 52 onto the conduit. In some cases this may include forming a shoulder 62 by biting into the conduit surface. This shoulder 62 will press against the front edge 58 of the gripping member 22 in response to pressure which will help prevent the conduit from backing out, and as pressure increases will cause the gripping member to grip even tighter. The supporting member 26 is shown in a somewhat stylized fashion to illustrate that it has plastically deformed as a result of the forces incurred during pull-up. In this embodiment, the collet ring interior wall 30 deforms to have a convex portion 64 that collets and/or swages the conduit to provide the vibration isolation for the bite region 60. The supporting member 26 also engages the gripping member 22 so as to support the gripping member should pressure tend to try to force the conduit back out of the fitting.

Although the exemplary embodiment illustrates the use of a conduit gripping member 22 in the form of a single spring, in alternative designs more than one conduit gripping member 22 may be used, and moreover an additional spring may be used to provide the colleting/swaging action of the supporting member 26. Still further in additional alternative embodiments, the various drive surfaces, camming surfaces, contact surfaces and so on may be shaped or contoured as needed to achieve a desired tube grip and seal.

Note from FIG. 3A that the forward surface 54 of the gripping member 22 may be used to form a fluid tight seal against the camming surface 48, and the indented region 60 may also form a seal against the conduit surface. Other techniques for providing fluid tight seal may be used either separately or in combination with the gripping member 22 and the supporting member 26.

The indented gripping member 22 thus provides grip and optional seal along the outer conduit surface (for example in the region generally indicated with the numeral 60), the gripping member 22 also provides a seal against the body surface 48 as in the region generally indicated with the numeral 66. These seals provide a fully sealed mechanical connection between the conduit end C and the fluid flow path through the body 12.

In order to further increase the pressure rating of the fitting 10, various parts or surfaces may be treated to be surface hardened as compared to the core material, and in some alternative designs various parts may be through hardened. One exemplary suitable process is low temperature carburization which produces a hardened surface that is substantially free of carbides in stainless steel alloys, however, other hardening processes including work hardening and non-low temperature carburizing, nitriding and others may be used as needed based on the desired hardness and corrosion resistance properties needed for a particular application. It may also be desirable in some designs to harden the entire surface of the conduit gripping member 22, or alternatively the inward portion 22a (FIG. 2) that will indent into and compress against the conduit C. This may be especially useful when the conduit comprises a hard alloy material, such as 2205 or 2507 duplex stainless steel, to name a few of many examples. It may also be desirable in some applications to harden the outer portion 38 of the gripping member 22 (FIG. 2), because just as the inner diameter of the spring washer 22 tends to decrease as the spring is flattened, the outer diameter tends to increase. By hardening the outer portion 38 this tendency to increase the diameter of the spring washer 22 will be lessened. In other applications, it may be desirable to harden the supporting member 26, portions or all of the drive member 24 or both.

As noted, the conduit gripping member 22 may have a basically conical shape, also called a Belleville or Belleville-like spring, which has a central hole 50 or inner diameter through which a conduit can pass. Pressing the spring axially so as to flatten it causes that central hole to decrease in diameter such that its edge indents into the surface of the conduit and grips the conduit in place. Configured in a conduit fitting, the flattening of a gripping spring is accomplished by pulling-up or advancing the drive member 24 relative to body such that surfaces adjacent to the gripping spring impart a toroidal flexure or flattening of the gripping spring. These adjacent surfaces start out having an angle α and β with the free and non-flexed conduit gripping spring, touching the spring generally at its radially inner most convex surface, and at its radially outermost concave surface. The gripping spring is configured in the conduit fitting with the convex side toward the source of system fluid elevated pressure. The gripping spring preferably maintains some amount of convexity toward the source of pressure, even after fitting pull-up. As that pressure attempts to push the conduit out from a pulled-up fitting, the inner diameter of the conduit gripping spring embeds deeper into the conduit surface. This provision of a greater grip in response to a greater pressure load to push out the conduit is called an energized conduit grip, a grip that increases to meet an increased conduit gripping requirement due to increasing system fluid pressure.

Embodiments that use a spring-like washer for the conduit gripping element 22 may be used to effect various advantages for the fitting designer. The spring-like member 22 may be tightened to a fully pulled-up condition as in FIG. 3 with a rather short stroke or displacement of the drive member 24 relative to the body 12. For example, the embodiment of FIGS. 1 and 2 may be fully made up with only a half-turn or even a quarter-turn of the drive member 24 relative to the body. The use of the generally flat gripping member(s) 22, even if more than one is used in a stacked configuration, provides a compact fitting design. The controlled deflection of the spring also facilitates the use and design of these fittings for thin walled conduits, as well has heavy walled conduits.

The pre-assembled modular or multi-piece nature of the fitting 10 allows for final assembly after a specific product design or configuration is identified. The selectable body 12 and the selectable end connectors are sealingly joined to form a final product such as illustrated in FIG. 1 for example. By postponing final assembly until the product configuration is identified, inventory requirements for such specialized configurations can be minimized, and product delivery times can be significantly reduced. Final assembly may even take place at a distributor or the end user facility rather than at the component manufacturer. In most cases, the modular parts such as the body 12 and the end connectors will be manufactured to final form for inventory so that the only major step needed upon an order receipt or product specification is the final joining of the modular parts.

The vast array of possible configurations will now be readily apparent to those skilled in the art. The body 12 may have any number of selectable configurations depending on how much variety in final product configuration is desired. For example, the body 12 may have two, three, four or more ports instead of the four ports illustrated herein to allow configurations such as t-fittings (three port for example), flow path splitting or mixing and so on. Rather than an elbow, the body 12 may be formed with a straight through flow path 18 to faun a straight for example. Many types of end connections and other components may be used that allow the fitting 10 to be connected into a fluid system such as a gas or liquid flow path for example. For example, but not by way of limitation, the end connectors may include various types of seal and coupling connections and configurations, including but not limited to a Swagelok tube fitting, female NPT, male NPT, VCO™, VCR™, plug, tube stub, SAE connection and ANSI flange. The end connectors may alternatively have a threaded connection with the body and, for example, screw into a threaded bore of the body. Thus, the manufacturer may provide a wide variety of selectable end connection configurations that can be selectively joined with a selectable body configuration to provide end product configurations from the simplest elbows and straights and t-fittings having the same end connection configuration used for all the ports, to much more complex fittings with multiple flow paths and a variety of end connections. It is readily apparent how the multi-piece modular concepts allow for postponement of final configuration and assembly, so that inventory may consist of the basic building blocks of a configurable body or selectable body configuration and selectable end connector configurations. This allows for the elimination of specialized end product inventory which is expensive or can result in long lead times for product delivery. Inventory of the final end product configuration can therefore be maintained at an end user or distributor rather than the manufacturer.

The modular base 12 need not be in the form of a block but may have any exterior shape or profile as required for particular situations. Moreover, the modular fitting concepts may be combined with flow devices, such as, for example, valves, regulators, manifolds and so on. In the case of a valve, for example, the body 12 may be part of or form a main valve body of a diaphragm or bellows valve or any other type of valve. The modular valve body may then have a selectable port configuration for being assembled with one or more selectable end connector configurations.

For non-metal fitting components, the various fitting parts may be sealingly joined by any available process, for example, thermal welding, adhesives and so on. Other techniques that may be used for non-metal to metal seals include but are not limited to direct molding of a non-metal material onto a metal component, or spraying a curing a non-metal material onto a metal component surface.

The modular fitting concepts herein may be used with a wide variety of tube and pipe and other metal conduits or non-metal conduits, from ⅛ inch or less to one inch and greater, and their metric equivalents. It will also be appreciated by those skilled in the art that the modular concepts herein for all metal fittings do not rely on plastic, elastomer or other non-metal seals (although such secondary parts may be used as needed) in order to achieve effective conduit grip, seal and vibration resistance.

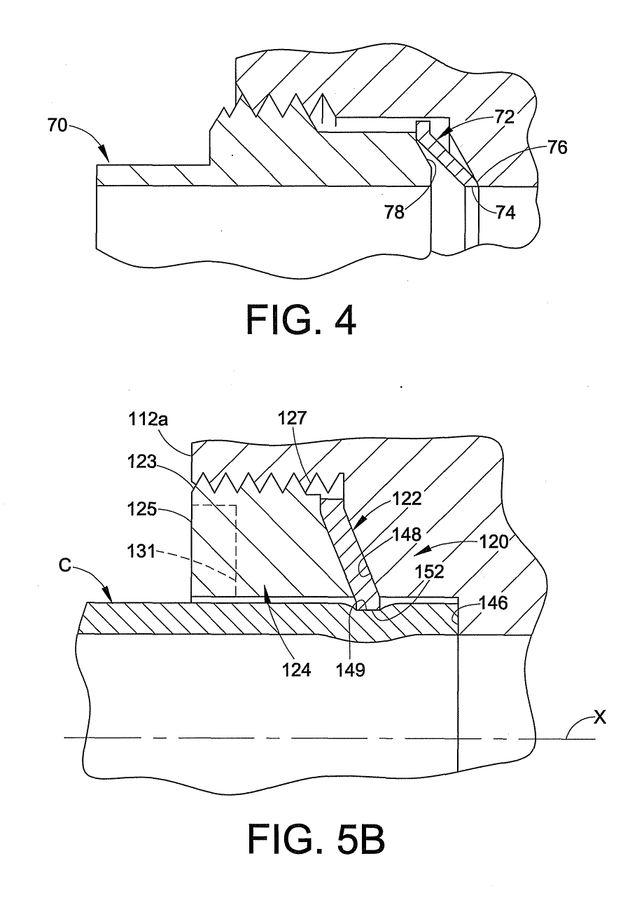

With reference to FIG. 4 we show an alternative embodiment of the connection assembly 20 of FIG. 2 in which the supporting member is omitted and the drive member 70 acts directly against the gripping member 72. In this example, the inner cylindrical wall 74 of the gripping member is designed to collet and/or swage the conduit axially behind the indented front edge 76. In this embodiment, the drive surface 78 may be tapered so as to facilitate the flattening of the spring 72 during pull up. This tapered surface may also alternatively be used in the embodiment of FIG. 2.

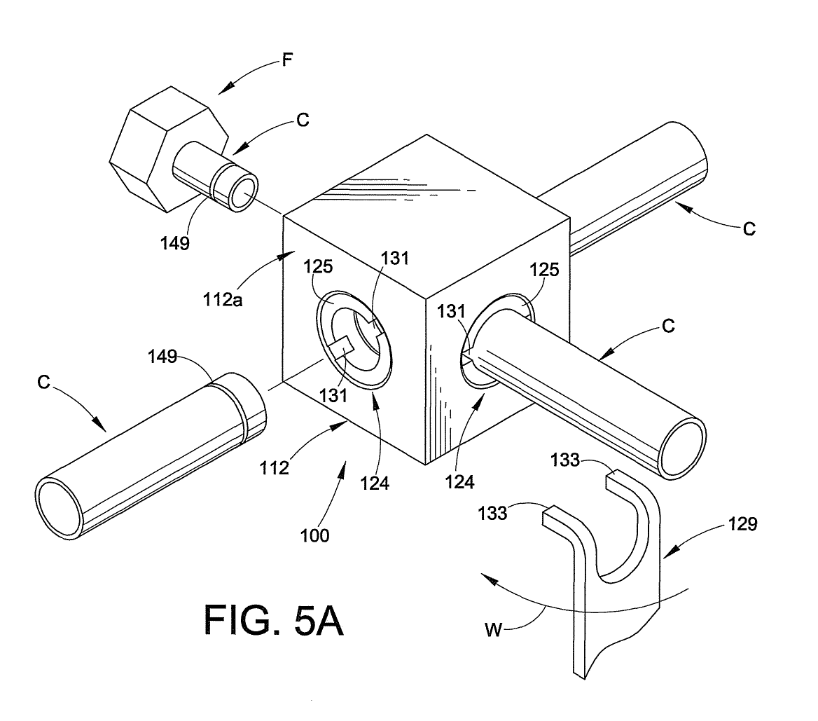

FIGS. 5A and 5B illustrate another embodiment of a modular fitting. FIG. 5A illustrates a partially assembled fitting in perspective and FIG. 5B is an enlarged longitudinal half cross-section along the central axis X of a conduit to illustrate a connection assembly in a pull-up condition.

FIG. 5A is similar in many respects to FIG. 1A, and illustrates a modular fitting 100 which in this example is a four port fitting. The fitting 100 includes a first fitting component or body 112 to which may be connected a wide variety of different type components. For example, a conduit C such as tube or pipe may be connected to the fitting, or a conduit with an end connector F. Such an end connector F may be, for example, a nut N and body (not shown) of a ferrule type tube fitting, also known as flareless fittings, or a flared fitting, a sanitary fitting such as a clamped fitting, or any other suitable end connection. A valve (see FIG. 1A) or any other type of flow component might also be connected to the fitting 100, such as for example, with a tube stub T. Yet another example might be a passive component such as a simple plug (FIG. 1A) used to close off a flow path otherwise available with the modular fitting 100. The examples are far too numerous to list even in categories, though active flow components, passive flow components, fittings, conduits and so on will give those skilled in the art an appreciation of the flexibility and ubiquitous application that the modular fitting provides. Although a four port modular fitting is illustrated herein, the present inventions are not limited to such a configuration as will be further described below, nor is a modular fitting restricted to any of the shapes and configurations shown herein.

In contrast to the FIGS. 1, 1A and 2 embodiment, this embodiment uses a modified drive member 124 that has an outer end 125 that may be flush or nearly flush or may even be recessed relative to a face or surface 112a of the body 112 when the fitting is fully assembled and pulled up. Many different techniques and apparatus may be used to tighten the drive member 124, which in this example has male threads 123 that form a threaded connection with a female threaded bore 127 (FIG. 5B) of the body 112. For example, a wrench 129, much like a spanner wrench, may be used to tighten the drive member 124. The drive member 124 is provided with slots, holes, recesses or other structure that can cooperate with prongs or legs 133 of the wrench 129. Rotation of the wrench 129 as indicated by the arrow W in one direction can be used to tighten and pull-up the connection, or re-make a connection, between the body 112 and the conduit C, while rotation in the opposite direction may be used to undo, loosen or disassemble the connection.

As illustrated in FIG. 5B, the connection assembly 120 may be similar to the embodiment of FIG. 4 herein in that the optional supporting member is not used. However, in other alternative designs a supporting member such as, for example, a collet or swage ring 26 (FIG. 2) may be used. The connection assembly 120 may include the drive member 124 which during tightening engages a conduit gripping member 122 and as the drive member 124 is axially advanced into the body 112, the gripping member 122 will tend to flatten, being axially constrained by a surface 148 of the body. Note further in this example that the gripping member indents into the conduit outer surface for excellent grip and seal. Preferably although not necessary in all cases, the conduit end bottoms against a shoulder 146 upon complete pull-up. As with the above described embodiments, pull-up may be achieved with a half-turn or even a quarter-turn of the drive member. Factors such as thread pitch will also determine the turns required for pull-up.

With reference again to FIG. 5A, the conduit end may optionally be prepared for connection by providing a groove or recess 149 at or near the location where the conduit gripping device 122 inner surface 152 engages the conduit. This groove concept may be used with the other embodiments described herein. Use of the groove or comparable features may facilitate assembly and pull-up by reducing pull-up torque requirements to achieve proper grip and seal.

With the compactness of the conduit gripping device 22, 122 in the various embodiments herein, such as in the form of the spring washer for example, a modular fitting concept using a universal or configurable block becomes highly practical. The overall fitting design using a conduit gripping spring can be made even more compact by incorporating the inward adjacent surface of the tube gripping spring integral with the body and by providing the opposite adjacent surface of the tube gripping spring integral with a flush drive nut, a slotted drive male threaded nut that assembles into the body flush with its surface

Apart from enabling modular fittings, such compact fittings will find application where space and weight are at a premium, in automotive systems for example, particularly if the body block and flush drive nuts are made from aluminum. As modular fittings, the body block can accommodate any of a wide range of fitting connection ends—flareless tube fitting, VCR fitting, NPT fitting, and just a simple plug end—to name a few. Each fitting connection end may have a conduit stub that inserts into and assembles in the body block. Assembly is accomplished by a wrench that straddles the conduit stub and turns in the slots of the flush drive nut. The conduit stub of fitting connection ends and plug ends (as well as a conduit end) may conveniently be pre-grooved about its circumference to position with and accommodate the decreasing diameter central hole of the tube gripping spring during pull-up. An important aspect of modular fittings is their allowance for the inventory and material management of only a small number of fitting components, and the non-inventory of any end-use fitting configurations. Customer and installer selection of fitting configurations are postponed until construction of the customer's fluid system. The easier, less involved inventory management of fitting components allows a lower cost tube connection solution to the customer.

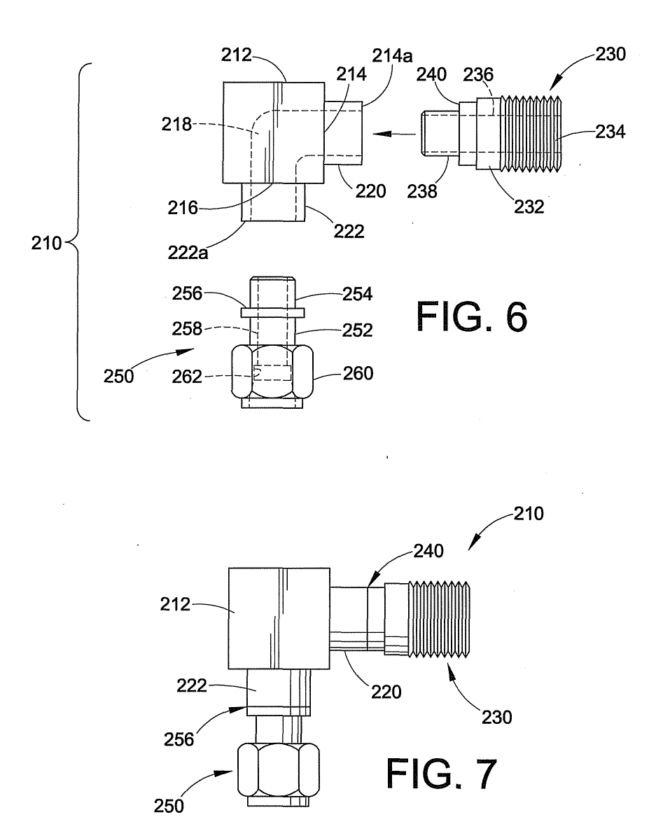

FIGS. 6 and 7 illustrate additional embodiments of a modular or multi-piece fitting 210. FIG. 6 illustrates the fitting in an unassembled condition, and FIG. 7 illustrates the fitting in a final assembly form. The fitting 210 includes a first part in the form of a configurable body or base 212. The body 212 in this example may be realized in the form of a block that includes a first port or opening 214, a second port or opening 216, and a internal flow passage 218 that connects the first and second ports. The body 212 may be manufactured by any suitable method including but not limited to machining from bar stock, forging, molding or casting. The passage 218 may be a machined formation or formed as part of a casting operation for example. The body 212 further includes optional annular female extensions 220 and 222, such as for example, tube stubs associated with the respective ports 214 and 216. With the modular fitting concepts of the present disclosure, one or more base configurations may be made available for selection.

The second part or additional parts of the modular fitting 210 may include one or more connection assemblies, which in these embodiments may be realized in the form of end connections or other components desired to be assembled into or with the fitting. In the present example, a first selectable end connection 230 may be realized, for example, in the form of a simple threaded connector having a connector body 232 threaded at one end, such as for example with SAE or NPT type standard threads 234. A connector flow passage 236 is formed through the connector body 232 and communicates with the first port 214 when the connector 230 is assembled with the body 212. The connector body 232 optionally includes an annular male extension or hub 238 that is inserted into the body extension 220. Preferably this is a snug or close fit so that the connector 230 may be welded, brazed or otherwise joined in a leak tight manner to the body 212. The snug fit also allows for good axial and radial alignment of the end connector 230 and body 212. The connector body 232 also optionally includes a raised shoulder 240 that abuts a distal end 214a of the body extension 214. This abutment provides visual and tactile feedback that the end connector 230 is fully inserted into the body 212 prior to welding, brazing or other joint process, and may also provide radial and axial stability and alignment prior to and during joining the parts by reducing tendency of the end connectors to cock or tilt during assembly. The shoulder 240 also provides a positive stop to prevent the end connector 230 from being forced too far into the body 212.

A second selectable end connection 250 may also be provided in the exemplary fitting 210. This second end connection may be in the form of a body 252 having a male extension or hub 254 that is closely received in the second body extension 222. Again, this close fit may be used to provide good axial and radial alignment between the end connector 250 and the body 212 prior to joining them by welding, brazing or other suitable process. The connector body 252 may also include a raised shoulder 256 that abuts a distal end 222a of the extension 222 when the end connector 250 is properly inserted into the extension 222, for axial positioning and radial alignment much like the shoulder 240 used with the first end connector 230. The second end connector body 252 also includes an internal flow passage 258 that communicates with the second port 216 upon final assembly. In this example, the second end connector 250 may further include structure that forms part of a compression type fitting, including a hex nut 260 and a conduit end receptacle 262. For example, the end connector 250 may include the male or female body half of a ferrule type compression fitting, such as for example taught in U.S. Pat. Nos. 4,826,218 and 3,103,373, or other ferrule type compression fittings. Alternatively, the end connector 250 may faun part of a face seal fitting such as a VCR brand face seal sold by Swagelok Company, Solon, Ohio.

The pre-assembled modular or multi-piece nature of the fitting 210 allows for final assembly after a specific product design or configuration is identified. The selectable body 212 and the selectable end connectors 230 and 250 are sealingly joined such as by welding, brazing or other suitable process to form the final product illustrated in FIG. 7. In this example, an elbow fitting is formed but having two distinctly different end connection configurations. By postponing final assembly until the product configuration is identified, inventory requirements for such specialized configurations can be minimized, and product delivery times can be significantly reduced. Final assembly may even take place at a distributor or the end user facility rather than at the component manufacturer. In most cases, but optionally, the modular parts such as the body 212 and the end connectors 230, 250 will be manufactured to final form for inventory so that the only major step needed upon an order receipt or product specification is the final joining of the modular parts.

The vast array of possible configurations will now be readily apparent to those skilled in the art. The body 212 may have any number of selectable configurations depending on how much variety in final product configuration is desired. For example, the body 212 may have three, four or more ports instead of two ports to allow configurations such as t-fittings (three port for example), flow path splitting or mixing and so on. Rather than an elbow, the body 212 may be formed with a straight through flow path 218 to form a straight for example. The body 212 may be formed with female recesses rather than the extensions or hubs 220, 222, or alternatively the body may include male extensions or hubs that insert into female extensions of the end connectors, or a combination thereof. Many types of end connections may be used that allow the fitting 210 to be connected into a fluid system such as a gas or liquid flow path for example. For example, but not by way of limitation, the end connectors may include various types of seal and coupling connections and configurations, including but not limited to a Swagelok tube fitting, female NPT, male NPT, VCO™, VCR™, plug, tube stub, SAE connection and ANSI flange. The end connectors may alternatively have a threaded connection with the body and, for example, screw into a threaded bore of the body. Thus, the manufacturer may provide a wide variety of selectable end connection configurations that can be selectively joined with a selectable body configuration to provide end product configurations from the simplest elbows and straights and t-fittings having the same end connection configuration used for all the ports, to much more complex fittings with multiple flow paths and a variety of end connections. It is readily apparent how the multi-piece modular concepts allow for postponement of final configuration and assembly, so that inventory may consist of the basic building blocks of a configurable body or selectable body configuration and selectable end connector configurations. This allows for the elimination of specialized end product inventory which is expensive or can result in long lead times for product delivery. Inventory of the final end product configuration can therefore be maintained at an end user or distributor rather than the manufacturer.

The modular base 212 need not be in the form of a block but may have any exterior shape or profile as required for particular situations. Moreover, the modular fitting concepts may be combined with flow devices, such as, for example, valves, regulators, manifolds, tanks and so on. In the case of a valve, for example, the body 212 may be part of or form a main valve body of a diaphragm or bellows valve or any other type of valve. The modular valve body may then have a selectable port configuration for being assembled with one or more selectable end connector configurations.

For non-metal fitting components, the various fitting parts may be sealingly joined by any available process, for example, thermal welding, adhesives and so on to name a few of the many well known examples.

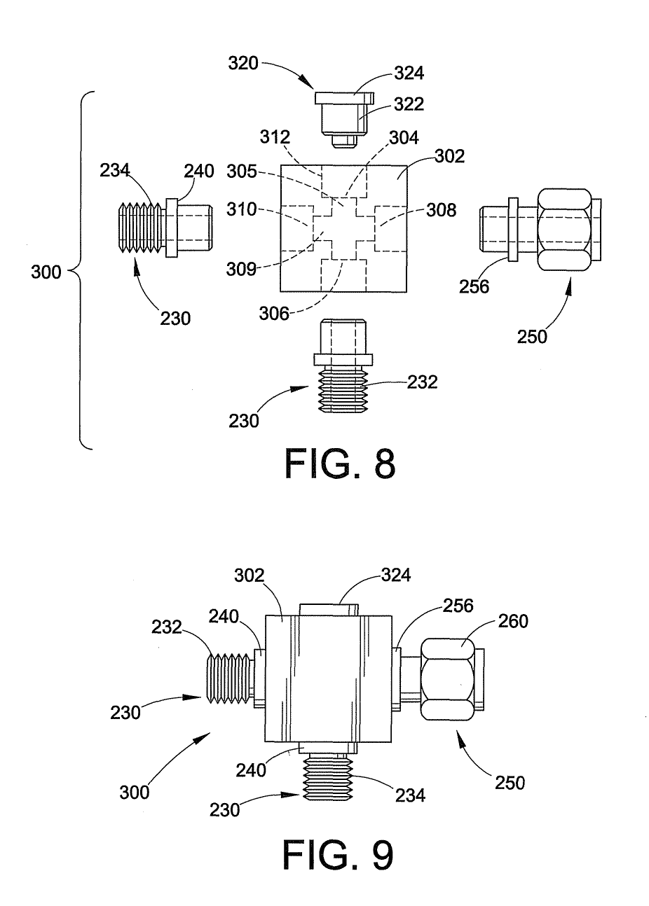

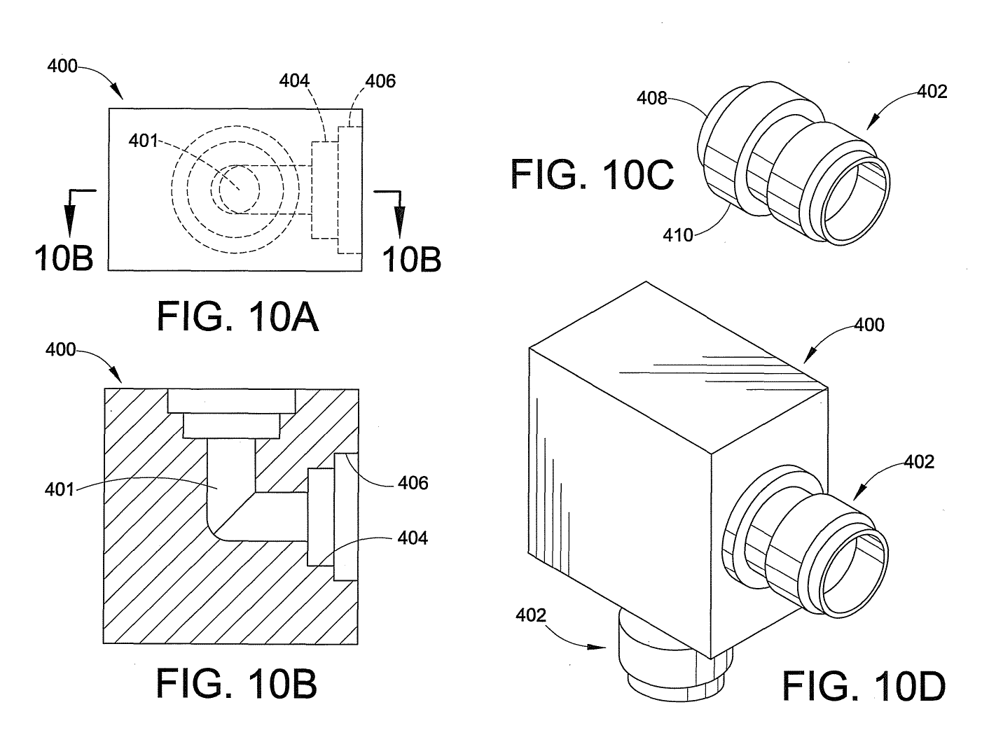

FIGS. 8 and 9 illustrate another embodiment of a modular fitting concept. In this example, a fitting 300 includes a configurable body 302 that includes four ports 304, 306, 308 and 310. In this embodiment, the ports may be recessed from the outer boundaries or faces of the body 302, such as via counterbores (for example counterbore 312 for the plug port 304). The counterbores provide cylindrical openings to receive the male extensions of the various selectable end connectors that may be used with the body 302. By having a close fit between the body 302 and the end connectors, good radial alignment is achieved for the welding or brazing operations, or other process used to join the parts together. Axial positioning may be achieved with the use of the shoulders on the end connectors as described above, or the distal ends of the male extensions of the connectors may bottom on the counterbores to indicate proper axial insertion.

The ports in this example communicate with two separate flow passages. Ports 304 and 306 communicate with a first flow passage 305 and ports 308 and 310 communicate with flow passage 309. Alternatively the flow passages 305 and 309 may interconnect within the body 302, or they may extend between different ports.

Other optional features that may be incorporated into the modular fitting concept include case or surface hardening of contact areas of the various components by low temperature carburizing techniques, or work hardening to name two examples. The hardened surfaces may be used to facilitate metal to metal seals as needed, to reduce galling and so on. The end connectors may also optionally include gaugeability features to verify proper axial and radial alignment after final assembly of the components. A modular fitting may also be realized with a base 212 that includes one or more recessed alignment features such as in FIG. 8 with one or more extension alignment features such as in FIG. 6.

For brazing operations, a brazing compound may be used. Often the brazing compound is a solid, so that the compound may be provided with the end connector or the body, but in any case the brazing compound may also optionally be or provide an alignment feature or facilitate alignment. The brazing compound may be integral with a component or part of the fitting or itself a separate piece of the assembly. One or more of the fitting components may also be provided with an alignment feature or other structural feature such as, for example, a metal to metal seal, that provides a barrier to protect the brazing compound from contact with the system fluid that will flow through the fitting.

For many end uses or applications, and in accordance with another inventive aspect of the disclosure, the modular fittings may be assembled using a braze compound that matches the corrosion resistance of the modular parts. In other words, the brazing compound may be closely matched or have an equivalent galvanic potential with the material of the components or parts being brazed together, particularly for components that will be exposed to an electrically conductive fluid, for example, sea water. For example, in many applications the modular parts (body and end connector for example) may comprise stainless steel or other high nickel alloys. The braze compound thus may also comprise sufficient chromium, nickel and other elemental content to match or closely match the elemental content of the modular parts. The braze compound and modular parts may thus have nearly equivalent galvanic potential for fitting configurations in which there is contact with an electrically conductive fluid. Examples of commercially available compounds that may be used include but are not limited to compounds and alloys comprising silver, copper, zinc, or tin, with chromium and nickel added.

The brazing operation not only joins the modular parts together at final assembly, but also may be used to provide metal to metal seal between the modular parts. A flux compound, chosen in relation to the braze compound and base material of the modular components, may be used to facilitate the brazing operation and to facilitate the metal to metal seals. Examples include but are not limited to fluxes containing boric acid, organic fluoride or hydrochloric acid, and fluxes, meeting the AWS-Type 3A specifications. Volumetric contraction of the braze compound during cooling may further facilitate the metal to metal seal. Still a further alternative, the various selectable axial and radial alignment features, for example the counterbore configuration in FIG. 8, provides structure that may act as a barrier to protect the braze compound from fluid contact.

End connectors 230 and 250 for example may be used with the four port body 302 as previously described herein above, or alternatively many different types of end connectors may be used. Another example is a plug 320 illustrated in FIG. 8. The plug 320 may simply be a blind insert having a cylindrical male extension 322 that inserts into the counterbore 312. The plug thus may reside flush with the outer surface of the body 302 as illustrated in FIG. 9 or an optional shoulder 324 may be provided for axial and radial alignment as described herein. A plug such as the plug 320 may be used for example to simply block flow through the port 304 to dead end a flow path or to use alternative flow paths. The plug 320 may be joined to the body 302 by welding, brazing or other suitable process as in the case of the other end connectors. The plug 320 may also be used as a cap or plug for an end connector without using a body. For example, a cap 320 may be brazed or welded into an end connector such as end connector 230, 232 or 250 for example.

FIG. 10 illustrates yet another alternative configuration for a selectable body 400 having an internal flow path 401 and selectable end connector 402. In this example, the body 400 has a first inner counterbore 404 and a second outer counterbore 406 of larger diameter than the first counterbore 404. The end connector 402 includes a port end 408 that is closely received in the first counterbore 404, and an annular cylindrical portion or land 410 that is closely received in the second counterbore 406. This configuration provides good axial and radial alignment of the parts for brazing or welding. Although FIG. 10 illustrates an elbow configuration, any end configuration may be used, as well as the body 400 being part of or Miming a flow component such as a valve, regulator and so on. As with all the embodiments herein, gauging features may be included for visual confirmation of proper assembly.

In addition to metallurgical processes such as welding and brazing for joining the fitting parts together, in some designs a press fit may be used wherein two parts are assembled with increasing resistance until the parts are fully assembled to a predetermined position or condition. The press fit method may optionally include a snap-fit type or snap-into-position feel with decreasing resistance. In such a case, for example, a snap fit connection may maintain a s seal against system fluid pressure in a number of ways. For example, in the assembled condition there can be sufficient residual load between the assembles parts at their circumferential zone of seal. Alternatively for example the seal zone may be responsive to fluid pressure so as to actually increase seal strength as system pressure increases.

Still as another example, the fitting components may be assembled with self-tapping threads. For example, a male threaded feature may be used to tap thread into a female feature. Surface hardening of the threads may help facilitate the self tapping assembly in many cases.

As yet another example, the fitting components may be joined using an adhesive. The adhesive may be a solid adhesive that helps align the parts, is integral with one or more of the parts or itself is a separate part. The adhesive may then be cured when the parts are joined together. Examples of adhesives that may be used with stainless steel parts include epoxies, urethane and methacrylate.

The modular fitting components may also alternatively be made from annealed round bar, for example. This may allow the manufacturer to avoid additional and expensive material operations like forging, casting, strain hardening or heat treating. The annealed materials assist in meeting NACE compatibility for sour (H2S) environments, as well as reducing lead times for exotic alloys such as inconel, hastelloy and titanium.

The modular fitting concept may be used with a wide variety of tube and pipe and other metal conduits, from ⅛ inch or less to one inch and greater, and their metric equivalents. The modular concepts herein are also applicable to fittings and assemblies made of non-metal parts, or combinations of metal and non-metal parts.

The inventive aspects have been described with reference to the exemplary embodiments. Modification and alterations will occur to others upon a reading and understanding of this specification. It is intended to include all such modifications and alterations insofar as they come within the scope of the appended claims or the equivalents thereof.

We claim:

1. A fitting for connecting to a conduit end portion, comprising:
a body having a selectable configuration including at least two ports and an internal flow passage between the ports;
at least one connector that when selectively joined to the body provides a flow path to one of the ports, the connector comprising a conduit gripping device in the form of a Bellville spring.

2. The fitting of claim 1 wherein the Bellville washer directly contacts a conduit end portion after the conduit end portion is inserted into the connector.

3. The fitting of claim 1 comprising a drive member adapted to be joined to the body and that engages the Bellville spring during pull-up of the fitting.

4. The fitting of claim 3 wherein the Bellville spring is axially compressed between the drive member and the body during pull-up of the fitting.

5. The fitting of claim 4 wherein the Bellville spring portion directly contacts an outer surface of the conduit end portion and upon complete pull-up of the fitting indents into the outer surface to grip the conduit.

6. The fitting of claim 1 comprising a supporting member disposed between said drive member and said conduit gripping device.

7. The fitting of claim 6 wherein said supporting member comprises an annular member that contacts the Bellville spring and is radially compressed against an outer surface of a conduit end portion axially behind said conduit gripping member during pull-up of the fitting.

8. The fitting of claim 7 wherein said supporting member is disposed between a drive member and said conduit gripping device, said drive member adapted to be joined to the body and that engages the Bellville spring during pull-up of the fitting.

9. The fitting of claim 3 wherein said drive member is threadably connected to the body.

10. A modular fitting for connecting to an end portion of a conduit, the fitting comprising: a body, a drive member that is adapted to be joined to the body, said drive member receiving an end portion of a conduit, and a conduit gripping member that engages the drive member during pull-up of the fitting, said conduit gripping member comprising a conical spring that is axially compressed between the drive member and the body during pull-up of the fitting.

11. The modular fitting of claim 10 wherein after the fitting is connected to a conduit end, said conduit gripping member provides conduit grip and a fluid tight seal.

12. The modular fitting of claim 10 wherein the conduit end portion is connected at one end to the fitting body and at another end is connectable to a flow device.

13. The modular fitting of claim 10 wherein said drive member is flush or recessed from an outer wall of said body after complete pull up of the fitting onto a conduit end.

14. The modular fitting of claim 10 comprising a supporting member disposed between said drive member and said conduit gripping device.

15. The modular fitting of claim 14 wherein said supporting member applies a radial compressive load against the conduit end portion axially behind said conduit gripping member to assist isolating said conduit gripping member from down conduit vibration or bending moments.

16. The modular fitting of claim 14 wherein said supporting member comprises an annular ring-like device.

17. A process for making a fitting, comprising:
forming a body having a selectable body configuration, forming a connector having a selectable connector configuration, and joining the body and connector to form a selected fitting configuration.

18. The process of claim 17 wherein the body and connector are separately formed at a manufacturer and the body and connector may be subsequently joined together at another location away from the manufacturing site to form a complete fitting.

19. The process of claim 17 wherein the body and connector are joined with a process that is postponed from the processes used for forming the body and connector.

20. A fitting, comprising:
a body having a selectable configuration including at least two ports and an internal flow passage between the ports;
at least one end connector that when selectively joined to the body provides a flow path to one of the ports, the end connector being joinable to the body at one end and having a selectable connector configuration at another end.

21. The fitting of claim 20 wherein the end connector is joined to the body by a weld or braze connection.

22. The fitting of claim 20 wherein the end connector is joined to the body using a brazing compound with closely matched galvanic potential.

23. The fitting of claim 20 wherein the end connector is joined to the body with a self tapping threaded connection.

24. The fitting of claim 20 wherein the end connector is joined to the body with low temperature carburized hardened surfaces to reduce galling.

25. The fitting of claim 20 wherein the end connector is joined to the body using adhesive or brazing compounds, and wherein a metal to metal seal presents a barrier between fluid in the fitting and said brazing or adhesive compound.
